(19) United States
(12) Patent Application Publication
(10) Pub. No.: US 2006/0288930 A1
(43) Pub. Date: Dec. 28, 2006

(54) Dispensing tip

(76) Inventor: Jerry Sullivan, Cuyahoga Falls, OH (US)

Correspondence Address: KATTEN MUCHIN ROSENMAN LLP, 575 MADISON AVENUE, NEW YORK, NY, 10022-2585, US

(21) Appl. No.: 11/450,885

(22) Filed: Jun. 9, 2006

Related U.S. Application Data
(60) Provisional application No. 60/689,226, filed on Jun. 10, 2005.

(51) Int. Cl. B41K 1/00

(52) U.S. Cl. 118/31.5

(57) ABSTRACT

A dispensing tip for extruding a thin flat ribbon of transparent setting material onto a fingerprint. The application tip includes a tubular portion that may be friction fitted to the end of a static mixer and a flared output portion with a cross-sectional area smaller than the cross-sectional area of the tubular input portion. The difference in cross-sectional areas causes the setting material to be extruded into a thin ribbon with a wide, flat cross-sectional shape.

The present invention claims priority from U.S. Provisional Application No. 60/689,226, filed Jun. 10, 2005.

### BACKGROUND OF THE INVENTION

1. Field of the Invention

The invention relates generally to methods and apparatus for acquiring and storing fingerprints for law enforcement and forensic purposes.

2. Discussion of the Prior Art

Methods for acquiring fingerprints are well known. Several problems or shortcomings result from these methods. Typically, powder is spread over the fingerprints and then, typically, a clear adhesive tape material is placed over the fingerprint to preserve the actual fingerprint for subsequent investigation. However, the use of such tape material, while transparent, does not have a permanent lasting quality. Additionally, using the traditional powder technique, it is particularly difficult to obtain “old” prints and prints on plastics. This is a real drawback because polythene is now a very common packaging material and is often used by criminals to wrap such things as contraband, explosives, and tools. As a result, other types of more permanent setting material have been utilized to preserve the actual fingerprint. However, these other materials form the fingerprint as a negative image in the setting material and thereafter a positive image has to be formed of the fingerprint for further use in investigation. In addition to requiring extra steps, the quality of the fingerprint image may be degraded by having to create an additional generation of the image.

Static mixers for combining gel materials are used in the dental field. Attachment tips have been used to extrude mixed materials onto a tooth. Using such attachment tips, which typically have parallel sides, to extrude gel materials creates a uniform, narrow bead with a square cross-sectional area equal to the static mixer's cross-sectional exit area suitable for dental applications. Such a narrow bead of material is not wide enough to span a typical fingerprint.

Accordingly, a need exists for methods and apparatus for acquiring and preserving fingerprints that are more permanent than adhesive tape and do not require extra steps to generate a positive image.

A further need exists for an apparatus that can extrude a setting material having a cross-sectional shape suitable for acquiring and preserving fingerprints.

Still a further need exists for a method of acquiring and preserving fingerprints in a permanent medium without having to degrade the image.

### SUMMARY OF THE INVENTION

In accordance with the invention, a general object is to provide an improved method and apparatus for acquiring and preserving fingerprints. A more specific objective of the invention is to overcome one or more of the problems described above. Therefore, it is an object of the present invention to provide an easily usable, simple, and adaptable dispensing tip for use in lifting fingerprints.

The object of the present invention is obtained through a dispensing tip adapted to allow a transparent setting material to be extruded into a thin, flat ribbon suitably wide enough to cover a fingerprint and yet thin enough to remain transparent. The inventive dispensing tip includes a tubular input portion that may be friction fitted to the end of a static mixer and a flared output portion that has a cross-sectional area that is smaller than the cross-sectional area of the tubular input portion. The difference in the cross-sectional areas of the input and output of the dispensing tip causes the setting material to be extruded into a thin ribbon with the desired wide, flat cross-sectional shape. When transparent setting material is so extruded onto a fingerprint, a first generation image of the fingerprint is captured and remains clearly visible through the material. When the material cures, a positive image of the fingerprint is preserved for use in further forensic investigation.

Therefore, it is an object of the present invention to provide an effective and commercially viable dispensing system for applying a thin transparent ribbon of setting material to fingerprints. Additionally, the dispensing tip of the present invention counterbalances the competing requirements that the setting material not prematurely set, that the setting material be easily applied, and that the setting material set at a desired rate upon application.

It is a further object of the present invention to provide a dispensing tip that provides increased precision in control of placement of the setting material. Accordingly, the dispensing tip allows setting material to be extruded onto a fingerprint in a precise pattern, i.e. a thin ribbon which was not possible using prior application systems, while maintaining control over the flow of the setting material.

In some embodiments, the dispensing tip may include a body portion that provides a smooth continuous transition from the input to the output of the dispensing tip. The dispensing tip can have any desired length, so long as the setting material is extruded in a thin transparent ribbon.

It is a further object of the present invention to provide a fingerprint developing kit which includes a setting material supply, a setting material, and a dispensing tip having a tubular input portion and a flared output portion that has a cross-sectional area that is small than the cross-sectional area of the tubular input portion.

The present invention still further provides a method to apply a transparent setting material to a fingerprint where the method involves extruding a thin ribbon of transparent setting material from a dispensing tip attached to a setting material supply, contacting a substrate containing fingerprints thereon with the transparent setting material, and preserving or recording the observable print, where the dispensing tip has a tubular input portion with a cross-sectional area of sufficient width to cover a fingerprint; and a flared output portion, coupled to the tubular input portion, having a cross-sectional area that is smaller than the cross-sectional area of the tubular input portion.

Other objects and advantages of the invention will become more readily apparent to those skilled in the art from the following detailed description in conjunction with the appended claims and drawings.

### BRIEF DESCRIPTION OF THE DRAWINGS

FIG. 1A is a right-sided perspective view of a preferred embodiment of the inventive dispensing tip according to the present invention.

FIG. 1B is a left-sided perspective view of a preferred embodiment of the inventive dispensing tip according to the present invention.

FIG. 2A is an elevational view of the front of the inventive dispensing tip of FIGS. 1A and 1B.

FIG. 2B is an elevational view of the top of the inventive dispensing tip of FIGS. 1A and 1B.

FIG. 2C is an elevational view of the bottom of the inventive dispensing tip of FIGS. 1A and 1B.

FIG. 2D is an elevational view of the right side of the inventive dispensing tip of FIGS. 1A and 1B.

FIG. 2E is an elevational view of the left side of the inventive dispensing tip of FIGS. 1A and 1B.

FIG. 3 is a perspective view of the inventive dispensing tip of FIGS. 1A and 1B coupled to a static mixer and in use extruding a thin ribbon of transparent setting material.

FIG. 4 is a perspective view of an alternative embodiment of an inventive dispensing tip according to the present invention.

### DETAILED DESCRIPTION OF THE INVENTION

The present invention provides a dispensing tip for extruding a thin ribbon of setting material for acquiring and preserving fingerprints. Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices. Furthermore, such terms as “tip,” “dispensing tip,” and “attachment tip” are used interchangeably.

As used herein, the term fingerprint denotes a unique pattern of ridges and valleys on fingers, palms, toes and soles of the feet. The dispensing tip may be used to apply setting material to latent, i.e. invisible to the naked eye without development, visible and molded fingerprints.

Although the invention is as described herein as being typically applicable to a single fingerprint, the overall, size, length and width, may be easily varied within the scope of this invention so that a complete set of prints, a palm print, or other latent indica of hand or foot identification may be obtained.

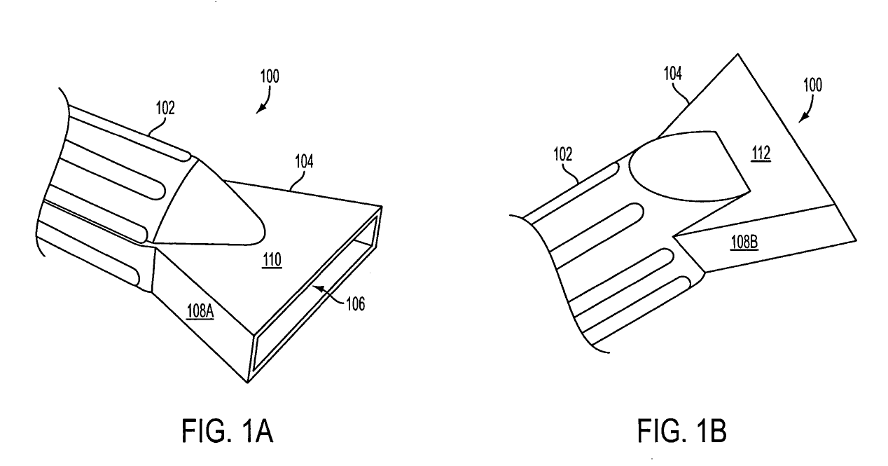

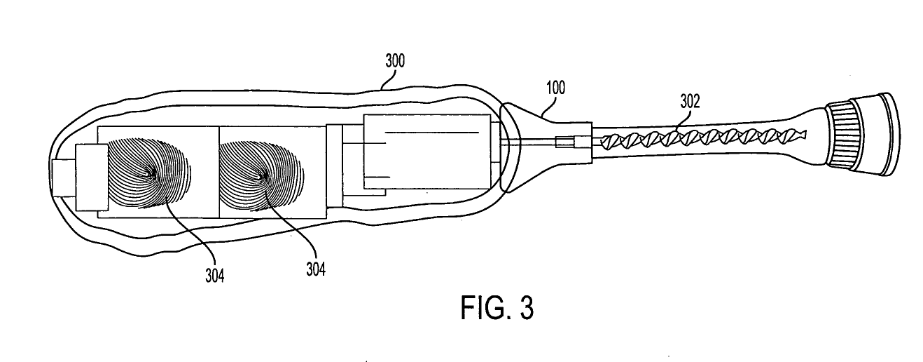

Turning now specifically to FIGS. 1A and 1B, perspective views of dispensing tip 100 are provided. FIG. 1A depicts a top view of the dispensing tip 100, and FIG. 1B depicts a bottom view of the dispensing tip 100. The inventive dispensing tip 100 is adapted to cause a transparent setting material extruded through the tip 100 to be formed into a thin, flat ribbon with a cross-section that is wide enough to cover a fingerprint and thin enough to remain transparent when the material cures. The inventive dispensing tip 100 includes a tubular input portion 102 coupled to a flared output portion 104. The tubular input portion 102 may be adapted to friction fit to a static mixer (300, FIG. 3) or other type of setting material supply. For example, the dispensing tip is attached or connected to an application device or apparatus, including but not limited to, an add-o-vial, a dual chamber syringe, or a rupturable container. In such systems, an activator is separated from the setting material and activation does not occur until the two components come into contact. It is apparent to those skilled in the art that the dispensing tip can be adapted for use with various types of setting material supply.

In some embodiments, the input portion 102 may be of another shape such as a triangular, square, oval, elliptical, trapezoidal, or rectangular cross-sectional shape. In some embodiments, the input portion 102 may include a snap-ring, catch, luer lock, threads, or other fastener for coupling the dispensing tip 100 to the static mixer or other type of setting material supply. Suitable mechanical connectors such as press-fitting, may also be used to removably connect the dispensing tip to the setting material The dispensing tip is attached to the outside of the setting material supply as shown in FIG. 3. In another embodiment, the dispensing tip is attached on the inside of the setting material supply.

The input portion 102 may also include grooves or other texturing to allow the dispensing tip 100 to be more easily handled and/or attached to the static mixer.

The flared output portion 104 of the dispensing tip 100 includes a rectangular opening 106 with a cross-sectional area shaped to form the desired thin, flat ribbon of material as material is extruded through the dispensing tip 100. The flared output portion 104 also includes flared sides 108A, 108B that are non-parallel to allow the extruded material to expand to be wide enough to span fingerprints. The top 110 and bottom 112 of the flared output portion 104 are close enough to each other to compress the material as it is extruded through the dispensing tip 100 so that the material expands to the flared sides 108A, 108B and assumes a flat, ribbon shape.

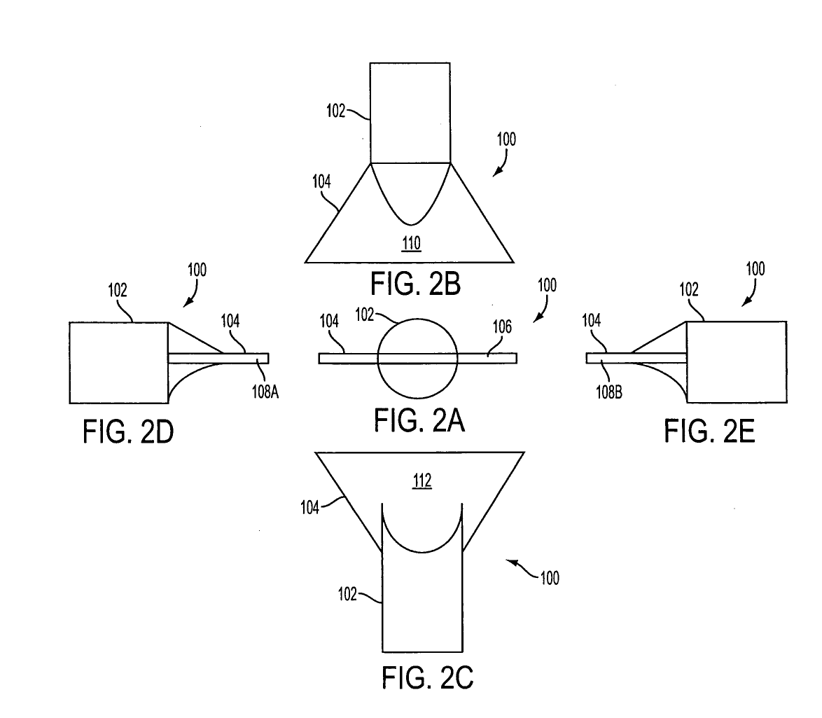

Turning to FIGS. 2A through 2E, elevational views of the front, top, bottom, right side and left side, respectively, of the inventive dispensing tip 100 are provided. Notably, the rectangular opening 106 of the flared output portion 104 has a cross-sectional area that is smaller than the cross-sectional area of the tubular input portion 102. The difference in the cross-sectional areas of the input 102 and output 106 of the dispensing tip 100 causes the setting material to be extruded into a thin ribbon with the desired wide, flat cross-sectional shape.

Turning to FIG. 3, according to the methods of the present invention, as transparent setting material 300 from a static mixer 302 is extruded or controllably urged through the dispensing tip 100 onto fingerprints 304 in a thin ribbon with the desired wide, flat cross-sectional shape, a first generation image of the fingerprint may be captured. Because the extruded material 300 is so thin, the fingerprints 304 remain visible through the material 300. When the material 300 cures, a positive image of the fingerprints are preserved for use in further forensic investigation.

The dispensing tip 100 may be made from metal, glass, ceramics, stone, composite material, or any suitable material compatible with the setting material. In some embodiments, inexpensive dispensing tips 100 may be constructed from injection molded plastic, thermoplastic, or other plastics to be disposable. In additional or alternative embodiments, the dispensing tip 100 may include a removable, friction fit cap (not shown) that may be inserted into the opening 106 to seal the setting material 300 from the air and prevent the setting material 300 from curing within the dispensing tip 100.

The setting material may be any transparent setting material known to those skilled in the art. The material may be monomeric materials, polymeric materials, or mixtures thereof, such as 1,1-disubstituted ethylene monomers and polymers. An example of a suitable setting material, includes but not limited to, a methyl, ethyl, or butyl cyanoacrylate monomer, which undergoes rapid anionic polymerization which exposed to oxygen and a weak base such as adsorbed water. The setting material may contain dyes to “tag’ the fingerprints to permit them to glow, e.g. monochromatic blue-green light may be added to the setting material.

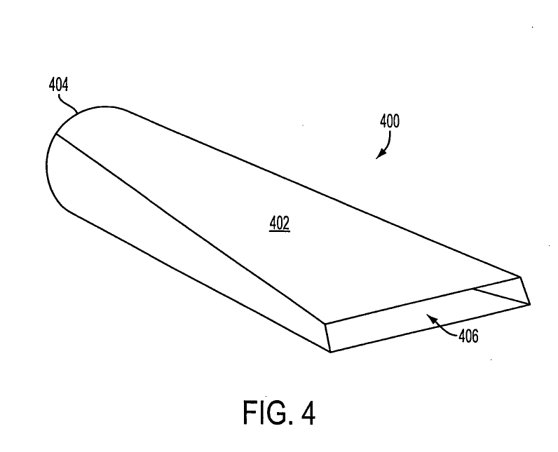

Turning to FIG. 4, in some alternative embodiments, a dispensing tip 400 may include a body portion 402 that provides a smooth continuous transition from the input 404 to the output 406 of the dispensing tip 404. The continuous transition body portion 402 may allow the setting material to flow more uniformly through the dispensing tip 404. In another embodiment, the dispensing tip and setting material supply are an integral unit. The unit may be preformed as a single piece.

The invention further comprehends an applicator tip molded in one piece without any sides or cams. The tip and extruded material is not limited to fingerprint impressions but may be used in any field where impressions are useful. Examples include, but are not limited to, law enforcement, forensics, e.g. wounds, scratches, or other evidence marks, dentistry, or the fields of anthropology, medicine, primatology, embryology, or genetics. In addition to use in fingerprint identification, the dispensing tip of the present invention may be used in biometric fingerprint applications, e,g, to identify children. The dispensing tip may be used for latent prints on any part of the body: such as the skin, palms, and feet.

This document describes the inventive dispending tip attachment for illustration purposes only. Neither the specific embodiments of the invention as a whole, nor those of its features limit the general principles underlying the invention. In particular, the invention is not limited to any specific configuration of dispending tip body shapes or texturing. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention.

The invention illustratively disclosed herein suitably may be practiced in the absence of any element, part or component which is not specifically disclosed herein.

What we claim is:

1. A dispensing tip for applying a setting material to a surface for an impression comprising:
a tubular input portion with a cross-sectional area of sufficient width to cover a fingerprint; and
a flared output portion, coupled to the tubular input portion, having a cross-sectional area that is smaller than the cross-sectional area of the tubular input portion.

2. The dispensing tip of claim 1, further comprising at least one orifice in the flared output portion where the setting material passes through the dispensing tip and exits the dispensing tip.

3. The dispensing tip of claim 1, wherein the difference in the cross-sectional area of the input and output causes the setting material to be extruded into a thin transparent ribbon having a wide, flat cross-sectional shape.

4. The dispensing tip of claim 2 wherein the setting material is extruded onto a fingertip.

5. The dispensing tip of claim 1 further comprising a body portion.

6. The dispensing tip of claim 5 wherein the body portion provides a smooth transition from the input portion to the output portion.

7. The dispensing tip of claim 1 comprising a material selected from the group consisting of metal, plastic, ceramics, stone, glass, and composite material.

8. The dispensing tip of claim 1, wherein the tubular input portion is connected to a setting material supply.

9. The dispensing tip of claim 8, wherein the setting material supply is a static mixer.

10. The dispensing tip of claim 8, wherein the setting material supply is a syringe.

11. The dispensing tip of claim 1, wherein the cross-sectional area of the tubular output portion has a shape selected from the group consisting of triangular, square, oval, elloptical, trapezoidal and rectangular.

12. The dispensing tip of claim 11, wherein the cross-sectional area of the tubular output portion is rectangular.

13. The dispensing tip of claim 11, wherein the cross-sectional area of the tubular output portion is square.

14. The dispensing tip of claim 8, where the input portion also comprises a fastener for coupling the dispensing tip to the setting material supply.

15. The dispensing tip of claim 14, wherein the fastener is selected from the group consisting of a snap-ring, catch luer lock, and threads.

16. The dispensing tip of claim 1, wherein said dispensing tip is made of plastic.

17. The dispensing tip of claim 1, wherein said dispensing tip is injection molded.

18. The dispensing tip of claim 1, wherein said input portion further comprises grooves or texturing.

19. A setting material application device comprising:
a setting material supply connected to a dispensing tip;
said dispensing tip having a tubular input portion with a cross-sectional area of sufficient width to cover a fingerprint; and
a flared output portion, coupled to the tubular input portion, having a cross-sectional area that is smaller than the cross-sectional area of the tubular input portion.

20. A method of applying a transparent setting material to fingertips; said method comprising the steps of:
extruding a thin ribbon of transparent setting material from a dispensing tip attached to a setting material supply;
contacting a substrate containing fingerprints thereon with the transparent setting material; and
preserving or recording the observable print;
wherein said dispensing tip comprises a tubular input portion with a cross-sectional area of sufficient width to cover a fingerprint; and
a flared output portion, coupled to the tubular input portion, having a cross-sectional area that is smaller than the cross-sectional area of the tubular input portion.

21. A kit for dispensing setting material comprising:
a setting material supply;
a dispensing tip connected to said setting material supply; wherein said dispensing tip
comprises a tubular input portion with a cross-sectional area of sufficient width to cover a fingerprint; and
a flared output portion, coupled to the tubular input portion, having a cross-sectional area that is smaller than the cross-sectional area of the tubular input portion.

22. A fingerprint formed by using the method of claim 20.
